(19) United States
(12) Patent Application Publication
(10) Pub. No.: US 2018/0293735 A1
(43) Pub. Date: Oct. 11, 2018

(54) OPTICAL FLOW AND SENSOR INPUT BASED BACKGROUND SUBTRACTION IN VIDEO CONTENT

(71) Applicant: SONY CORPORATION, TOKYO (JP)

(72) Inventors: PINGSHAN LI, Sunnyvale, CA (US); JUNJI SHIMADA, Tokyo (JP)

(21) Appl. No.: 15/484,811

(22) Filed: Apr. 11, 2017

(51) Int. Cl. G06T 7/194; G06T 7/215; G06T 7/136

(52) U.S. Cl. CPC G06T 7/194; G06T 7/136; G06T 7/215

(57) ABSTRACT

An apparatus and method for optical flow and sensor input based background subtraction in video content, includes one or more processors configured to compute a plurality of first motion vector values for a plurality of pixels in a current image frame with respect to a previous image frame using an optical flow map. A plurality of second motion vector values are computed for the plurality of pixels in the current image frame based on an input received from a sensor provided in the apparatus. A confidence score is determined for the plurality of first motion vector values based on a set of defined parameters. One or more background regions are extracted from the current image frame based on the determined confidence score and a similarity parameter between the plurality of first motion vector values and the plurality of second motion vector values.

### CROSS-REFERENCE TO RELATED APPLICATIONS/INCORPORATION BY REFERENCE

None.

### FIELD

Various embodiments of the disclosure relate to background-foreground segregation technologies. More specifically, various embodiments of the disclosure relate to an optical flow and sensor input based background subtraction in video content.

### BACKGROUND

Recent advancements in the field of computer vision have led to development of various techniques for background and foreground detection in video content. Such techniques for background and foreground detection and segregation in the video content may be useful in various applications, for example, video-surveillance applications or auto-focus applications.

Background detection and subtraction (or removal) in a sequence of images may be performed based on an optical flow procedure. The optical flow procedure is based on an assumption that a background region usually covers the largest portion of a captured image frame, and thus the largest area in an image frame is identified as background region by the optical flow procedure. In certain scenarios, objects may be near to an image-capture device during an image/video capture. In such scenarios, the foreground region may cover majority portion of the captured image frame and background region becomes relatively smaller. In such scenarios, the optical flow procedure-based techniques may lead to removal of objects-of-interest during background subtraction. Thus, an improved system and method for background subtraction may be required to overcome the problems associated with inaccurate background detection and subtraction.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

An optical flow and sensor input based for background subtraction in video content is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates an exemplary network environment for optical flow and sensor input based background subtraction in video content, in accordance with an embodiment of the disclosure.

FIG. 2 is a block diagram that illustrates an exemplary image-processing apparatus, in accordance with an embodiment of the disclosure.

FIG. 3 illustrates an exemplary scenario for optical flow and sensor input based background subtraction in video content, in accordance with an embodiment of the disclosure.

FIGS. 4A and 4B, collectively, depict a flowchart that illustrates exemplary operations for optical flow and sensor input based background subtraction in video content, in accordance with an embodiment of the disclosure.

### DETAILED DESCRIPTION

The following described implementations may be found in the disclosed apparatus and method for optical flow and sensor input based background subtraction in video content. Exemplary aspects of the disclosure may include an apparatus that may further include one or more processors configured to capture a sequence of image frames. The sequence of image frames may include at least a current image frame and a previous image frame. The one or more processors may be configured to compute a plurality of first motion vector values for a plurality of pixels in a current image frame with respect to a previous image frame using an optical flow map. The optical flow map may be generated based on a difference of pixel values of the plurality of pixels in the current image frame and the previous image frame. The current image frame may comprise one or more foreground regions and one or more background regions. A plurality of second motion vector values may also be computed for the plurality of pixels in the current image frame based on an input received from a sensor provided in the apparatus. The received input may correspond to angular velocity information of each of the plurality of pixels in the current image frame. A confidence score for the plurality of first motion vector values may be determined based on a set of defined parameters. The one or more background regions from the current image frame may be extracted based on the determined confidence score and a similarity parameter between the plurality of first motion vector values and the plurality of second motion vector values.

Each of the plurality of first motion vector values may correspond to a relative movement of each of the plurality of pixels from the previous image frame to the current image frame. The plurality of second motion vector values may correspond to a plurality of motion vector values computed for a gyro sensor (or other motion sensor) provided in the apparatus. The computation of the plurality of second motion vector values may be further based on one or more device parameters of the apparatus. The one or more device parameters may include a focal length of a lens of the apparatus, a number of horizontal pixels, and a width of an imager component provided in the apparatus.

In accordance with an embodiment, the one or more processors in the apparatus may be further configured to compare the plurality of second motion vector values with the plurality of first motion vector values of the plurality of pixels for extraction of the one or more background regions. The similarity parameter for each of the plurality of pixels in the current image frame may be determined based on the comparison between the plurality of second motion vector values and the plurality of first motion vector values. A confidence map may be generated based on the confidence score and the similarity parameter related to each of the plurality of pixels. The one or more background regions may be extracted based on a comparison of the determined similarity parameter related to each of the plurality of pixels with a specified threshold value.

In accordance with an exemplary aspect of the disclosure, the image-processing system may include one or more processors in an imaging device, which may be configured to compute a plurality of first motion vector values for a plurality of pixels in a current image frame with respect to a previous image frame using an optical flow map. The optical flow map may be generated based on a difference of pixel values of the plurality of pixels in the current image frame and the previous image frame. The current image frame may comprise one or more foreground regions and one or more background regions. A plurality of second motion vector values may be computed for the plurality of pixels in the current image frame based on an input received from a sensor provided in the apparatus. The received input may correspond to angular velocity information of each of the plurality of pixels in the current image frame. A confidence score for the plurality of first motion vector values may be determined based on a set of defined parameters. The one or more background regions from the current image frame may be extracted based on the determined confidence score and a similarity parameter between the plurality of first motion vector values and the plurality of second motion vector values. The one or more processors in the imaging device may be further configured to detect one or more objects-of-interest in the current image frame based on the extracted one or more background regions. The detected one or more objects-of-interest may correspond to one or more objects in motion in the current image frame. The one or more processors in the imaging device may autofocus the detected one or more objects-of-interest. One or more visual parameters of the detected one or more objects-of-interest may be modified by the imaging device.

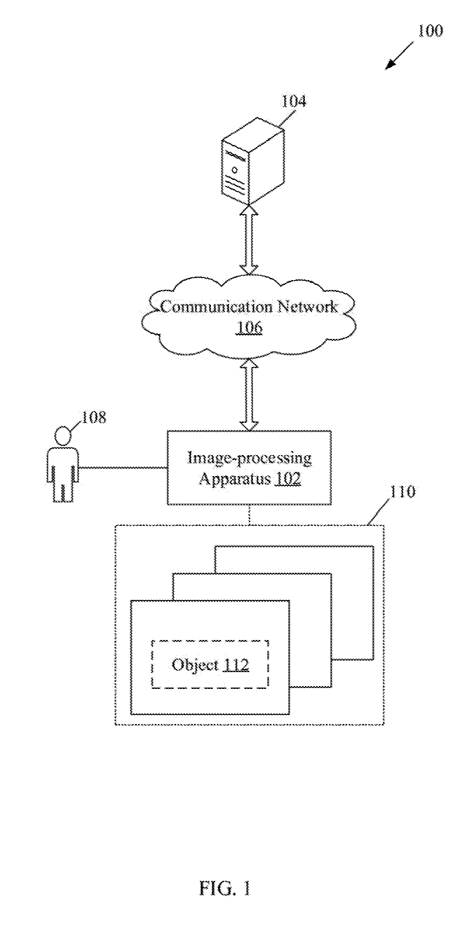

FIG. 1 is a block diagram that illustrates an optical flow and sensor input based background subtraction in video content, in accordance with an embodiment of the disclosure. With reference to FIG. 1, there is shown a network environment 100. The network environment 100 may include an image-processing apparatus 102, a server 104, a communication network 106, one or more users, such as a user 108, a sequence of image frames 110, and one or more objects, such as an object 112. With reference to FIG. 1, the image-processing apparatus 102 may be communicatively coupled to the server 104, via the communication network 106. The user 108 may be associated with the image-processing apparatus 102.

The image-processing apparatus 102 may comprise suitable logic, circuitry, interfaces, and/or code that may be configured to process one or more digital images and/or videos for background subtraction. The image-processing apparatus 102 may be configured to capture the sequence of image frames 110 that includes the object 112. The image-processing apparatus 102 may be further configured to process the captured sequence of image frames 110 for background subtraction. Examples of the image-processing apparatus 102 may include, but are not limited to, an imaging device (such as a digital camera, a camcorder), a motion-capture system, a camera phone, a projector, a computer workstation, a mainframe computer, a handheld computer, a cellular/mobile phone, a smart appliance, a video player, a DVD writer/player, a television, and/or other computing device.

The server 104 may comprise suitable logic, circuitry, interfaces, and/or code that may be configured to communicate with the image-processing apparatus 102. The server 104 may further include one or more storage systems that may be configured to store a plurality of digital images and/or videos. Examples of the server 104 may include, but are not limited to a web server, a database server, a file server, an application server, a cloud server, or a combination thereof.

The communication network 106 may include a medium through which the image-processing apparatus 102 may communicate with the server 104. Examples of the communication network 106 may include, but are not limited to, the Internet, a cloud network, a Long Term Evolution (LTE) network, a Wireless Local Area Network (WLAN), a Local Area Network (LAN), a telephone line (POTS), and/or a Metropolitan Area Network (MAN). Various devices in the network environment 100 may be configured to connect to the communication network 106, in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), ZigBee, EDGE, IEEE 802.11, light fidelity (Li-Fi), 802.16, IEEE 802.11s, IEEE 802.11g, multi-hop communication, wireless access point (AP), device to device communication, cellular communication protocols, or Bluetooth (BT) communication protocols, or a combination thereof.

The sequence of image frames 110 may refer to a video of a scene as viewed from a viewfinder of an imaging device and captured by the user 108, by use of the image-processing apparatus 102. The sequence of image frames 110 may include one or more objects, such as the object 112. In accordance with an embodiment, the object 112 may be an object-of-interest that may constitute a foreground region in the sequence of image frames 110. The sequence of image frames 110 may further include one or more background regions. For example, any region apart from the foreground region in the sequence of image frames 110 may correspond to a background region.

The object 112 may be a moving object, a deforming object that changes its shape over a period of time, or an object located at a same position but in a different orientation at different time instances in the captured sequence of image frames 110. Examples of the object 112 may include, but are not limited to a human object, an animal, or a non-human or inanimate object, such as a vehicle or a sports item.

In operation, the image-processing apparatus 102 may correspond to an imaging device that may be used to capture a video of a scene. The video may include a sequence of image frames (such as the sequence of image frames 110) that includes at least a current image frame and a previous image frame. The captured sequence of image frames 110 may further include one or more objects-of-interest (such as the object 112). The one or more objects-of-interest may constitute the one or more foreground regions and any region apart from the one or more objects-of-interest may constitute the one or more background regions in the sequence of image frames 110.

The image-processing apparatus 102 may be configured to compute a plurality of first motion vector values for a plurality of pixels in the current image frame with respect to the previous image frame. The image-processing apparatus 102 may be configured to use an optical flow map to compute the plurality of first motion vector values. The optical flow map may be generated based on a difference of pixel values of the plurality of pixels in the current image frame and the previous image frame. The plurality of first motion vector values may correspond to a relative movement of each of the plurality of pixels from the previous image frame to the current image frame.

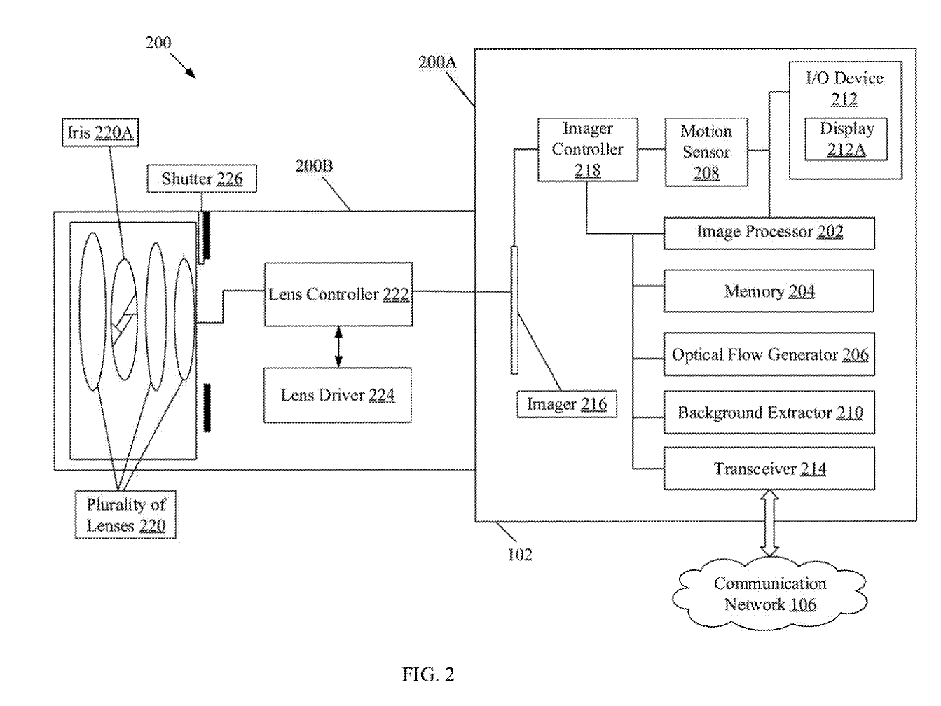

The image-processing apparatus 102 may be further configured to compute a plurality of second motion vector values for the plurality of pixels in the current image frame. The plurality of second motion vector values may be computed based on an input received from a sensor provided in the image-processing apparatus 102. For example, the input received from the sensor may correspond to angular velocity information of each of the plurality of pixels in the current image frame. The sensor included in the image-processing apparatus 102 may correspond to a motion sensor, such as a gyro sensor. The plurality of second motion vector values may correspond to a plurality of motion vector values computed for the sensor (e.g. the gyro sensor) provided in the image-processing apparatus 102. The computation of the plurality of first motion vector values and the plurality of second motion vector values is explained in detail in FIG. 2.

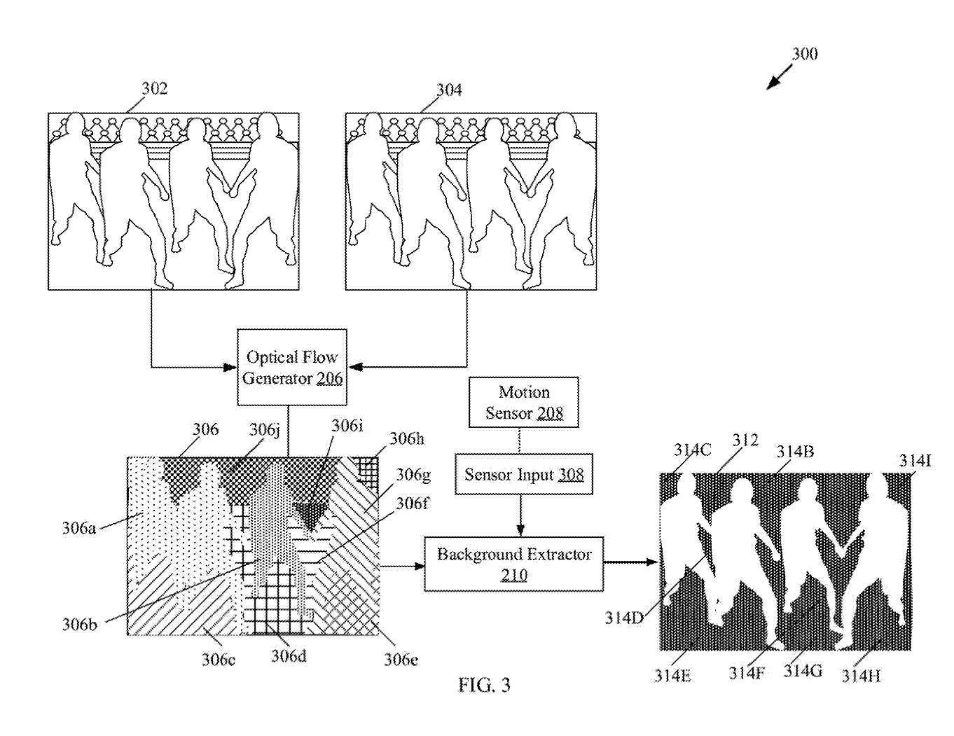

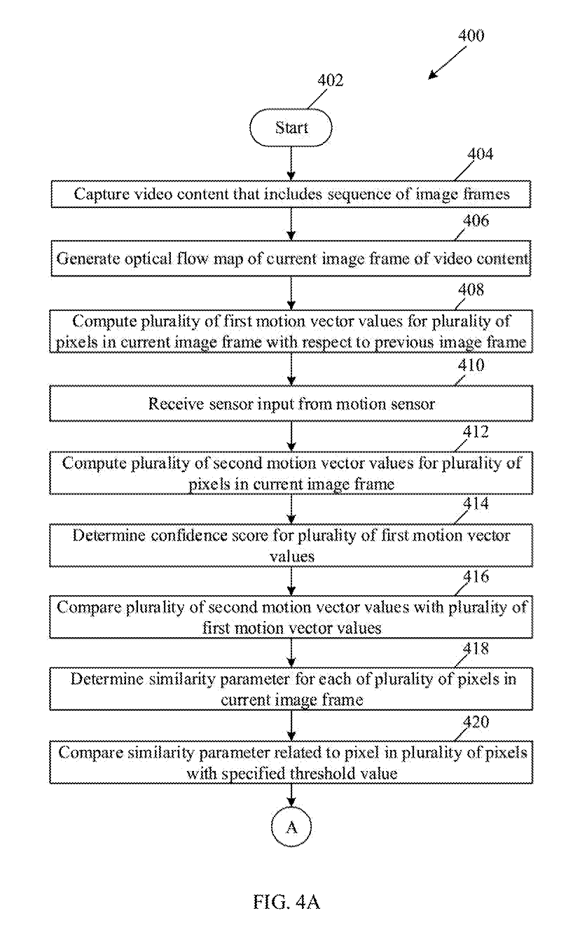

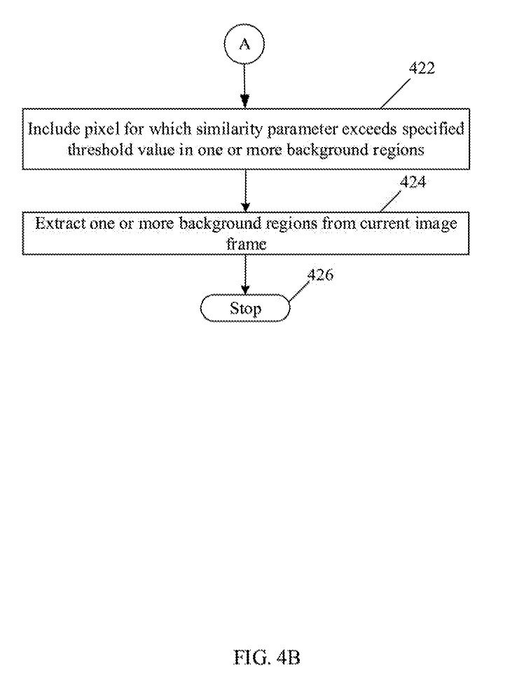

The image-processing apparatus 102 may be further configured to determine a confidence score for the computed plurality of first motion vector values based on a set of defined parameters. For example, the set of defined parameters may include, but is not limited to, an area covered by a foreground object(s) in an image frame with respect to total area of the image frame and/or a contrast level of the image frame. The image-processing apparatus 102 may be further configured to compare the computed plurality of first motion vector values with the plurality of second motion vector values of each of the plurality of pixels in the current image frame. A similarity parameter may be determined for each of the plurality of pixels in the current image frame based on the comparison between the plurality of second motion vector values and the plurality of first motion vector values. The similarity parameter related to a pixel may indicate a degree of similarity between the corresponding first motion vector value and the corresponding second motion vector value. The image-processing apparatus 102 may be further configured to compare the similarity parameter for each of the plurality of pixels in the current image frame with a specified threshold value to extract the one or more background regions from the current image frame. For example, the image-processing apparatus 102 may extract one or more pixels from the current image frame for which the similarity parameter exceeds the specified threshold value. The extracted one or more pixels may constitute the extracted one or more background regions. The extraction of the one or more background regions is explained, for example, in detail in FIGS. 3, and 4A and 4B.

In accordance with an embodiment, the image-processing apparatus 102 may be further configured to generate a confidence map based on the determined confidence score and the determined similarity parameter for each of the plurality of pixels. The generated confidence map may indicate the confidence level with which detection and extraction of each of the one or more background regions may be achieved. The confidence level may be represented numerically by a confidence score. A confidence map may graphically represent the extracted one or more background regions in accordance with the confidence scores. In accordance with an embodiment, the image-processing apparatus 102 may be configured to use spatial information for the computation of the plurality of first motion vector values based on the determined confidence score for the plurality of first motion vector values when determined confidence score is below a pre-defined or defined lower confidence threshold value. The pre-defined or defined lower confidence threshold value may be defined previously by the user 108 or refer to specified threshold setting.

In accordance with an embodiment, the image-processing apparatus 102 may be configured to extract the one or more background regions based on the plurality of first motion vector values when the determined confidence score for the plurality of first motion vector values is above a pre-defined or defined upper confidence threshold value. In accordance with yet another embodiment, the image-processing apparatus 102 may be configured to extract the one or more background regions based on the plurality of first motion vector values and the plurality of second motion vector values when the determined confidence score for the plurality of first motion vector values is in a specified range of the pre-defined or defined lower confidence threshold value and the pre-defined or defined upper confidence threshold value.

In accordance with an embodiment, the image-processing apparatus 102 may be configured to utilize the extracted one or more background regions to detect the one or more objects-of-interest in the current image frame. The image-processing apparatus 102 may further utilize the generated confidence map to detect the one or more objects-of-interest. Once the one or more background regions are accurately extracted, the image-processing apparatus 102 may execute one or more image processing operations (such as to auto-focus on the one or more objects-of-interest or modification of visual parameters of the one or more objects-of-interest) on the detected one or more objects-of-interest.

FIG. 2 is a block diagram that illustrates an exemplary image-processing apparatus, in accordance with an embodiment of the disclosure. FIG. 2 is explained in conjunction with elements from FIG. 1. With reference to FIG. 2, there is shown a block diagram 200 implemented in the image-processing apparatus 102. The block diagram 200 may include a processing circuitry 200A and an optical circuitry 200B. The processing circuitry 200A may include one or more processors, such as an image processor 202, a memory 204, an optical flow generator 206, a motion sensor 208, a background extractor 210, an input/output (I/O) device 212, and a transceiver 214. The I/O device 212 may further include a display 212A. The optical circuitry 200B may include an imager 216, with defined dimensions, controlled by an imager controller 218 for steady-shot. The optical circuitry 200B may further include a plurality of lenses 220, controlled by a lens controller 222 and a lens driver 224. The plurality of lenses 220 may further include an iris 220A.

There is further shown a shutter 226 in the optical circuitry 200B. The shutter 226 may allow light to pass for a determined period, exposing the imager 216 to light in order to capture the sequence of image frames 110.

Although the block diagram 200 is shown to be implemented in an exemplary image-processing apparatus, such as the image-processing apparatus 102, the various embodiment of the disclosure is not so limited. Accordingly, in accordance with an embodiment, the block diagram 200 may be implemented in an exemplary server, such as the server 104, without deviation from the scope of the various embodiments of the disclosure.

With reference to FIG. 2, the memory 204, the optical flow generator 206, the motion sensor 208, the background extractor 210, the input/output (I/O) device 212, and the transceiver 214 may be communicatively connected to the image processor 202. The background extractor 210 may be configured to receive an optical flow map of the sequence of image frames 110 from the optical flow generator 206 and an input from the motion sensor 208. The plurality of lenses 220 may be in connection with the lens controller 222 and the lens driver 224. The plurality of lenses 220 may be controlled by the lens controller 222 in association with the image processor 202.

The image processor 202 may comprise suitable logic, circuitry, interfaces, and/or code that may be configured to execute a set of instructions stored in the memory 204. The image processor 202 may be configured to instruct the background extractor 210 to extract one or more background regions from the sequence of image frames 110, captured by the image-processing apparatus 102. The image processor 202 may be a specialized image processing application processor, implemented based on a number of processor technologies known in the art. Examples of the image processor 202 may be an X86-based processor, a Reduced Instruction Set Computing (RISC) processor, an Application-Specific Integrated Circuit (ASIC) processor, a Complex Instruction Set Computing (CISC) processor, and/or other hardware processors.

The memory 204 may comprise suitable logic, circuitry, and/or interfaces that may be configured to store a set of instructions executable by the image processor 202, the optical flow generator 206, and the background extractor 210. The memory 204 may be configured to store the sequence of image frames 110 (such as a current image frame and a previous image frame) captured by the image-processing apparatus 102. The memory 204 may be further configured to store operating systems and associated applications of the image-processing apparatus 102. Examples of implementation of the memory 204 may include, but are not limited to, Random Access Memory (RAM), Read Only Memory (ROM), Hard Disk Drive (HDD), and/or a flash drive.

The optical flow generator 206 may comprise suitable logic, circuitry, and/or interfaces that may be configured to receive from the memory 204, the sequence of image frames 110 of the video content, captured by the image-processing apparatus 102. The optical flow generator 206 may be further configured to generate an optical flow map based on the current image frame in the sequence of image frames 110 and an image frame that lies prior to the current image frame in the sequence of image frames 110. The image frame which lies prior to the current image frame may be referred to as the previous image frame. Examples of the optical flow generator 206 may include an X86-based processor, a RISC processor, an ASIC processor, a CISC processor, and/or other hardware processors. The optical flow generator 206 may be implemented as a separate processor or circuitry (as shown) in the image-processing apparatus 102. In accordance with an embodiment, the optical flow generator 206 and the image processor 202 may be implemented as an integrated processor or a cluster of processors that perform the functions of the optical flow generator 206 and the image processor 202.

The motion sensor 208 may comprise suitable logic, circuitry, interfaces, and/or code that may be configured to detect movement (linear or angular) in an apparatus, such as the image-processing apparatus 102. For example, the motion sensor 208 may be configured to detect angular velocity information of a plurality of pixels in an image frame in the sequence of image frames 110. Examples of implementation of the motion sensor 208 may include, but are not limited to, a gyro sensor, an accelerometer, and/or the like.

The background extractor 210 may comprise suitable logic, circuitry, and/or interfaces that may be configured to extract the one or more background regions from an image frame (such as the current image frame in the sequence of image frames 110). The background extractor 210 may be configured to implement various algorithms and mathematical functions for computation of a plurality of first motion vector values for a plurality of pixels in the current image frame with respect to the previous image frame. The plurality of first motion vector values may be computed using the optical flow map generated by the optical flow generator 206. The plurality of first motion vector values may correspond to a relative movement of each of the plurality of pixels from the previous image frame to the current image frame. The background extractor 210 may be further configured to implement various algorithms and mathematical functions for computation of a plurality of second motion vector values for the plurality of pixels in the current image frame based on an input (such as the angular velocity information) received from the motion sensor 208. The extraction of the one or more background regions in the current image frame may be based on the computed plurality of first motion vector values and the computed plurality of second motion vector values. The background extractor 210 may be implemented as a separate processor or circuitry (as shown) in the image-processing apparatus 102. In accordance with an embodiment, the background extractor 210 and the image processor 202 may be implemented as an integrated processor or a cluster of processors that perform the functions of the background extractor 210 and the image processor 202.

The I/O device 212 may comprise suitable logic, circuitry, interfaces, and/or code that may be configured to receive an input from a user, such as the user 108. The I/O device 212 may be further configured to provide an output to the user 108. The I/O device 212 may comprise various input and output devices that may be configured to communicate with the image processor 202. Examples of the input devices may include, but is not limited to, a touch screen, a keyboard, a mouse, a joystick, a microphone, and/or an image-capture device. Examples of the output devices may include, but is not limited to, the display 212A and/or a speaker.

The display 212A may comprise suitable logic, circuitry, interfaces, and/or code that may be configured to display the extracted one or more background regions to the user 108. The display 212A may be realized through several known technologies, such as, but is not limited to, at least one of a Liquid Crystal Display (LCD) display, a Light Emitting Diode (LED) display, a plasma display, and/or an Organic LED (OLED) display technology, and/or other display. In accordance with an embodiment, the display 212A may refer to various output devices, such as a display screen of smart-glass device, a projection-based display, an electro-chromic display, and/or a transparent display.

The transceiver 214 may comprise suitable logic, circuitry, interfaces, and/or code that may be configured to transmit the sequence of image frames 110 to the server 104, via the communication network 106. The transceiver 214 may implement known technologies to support wired or wireless communication with the communication network 106. The transceiver 214 may include, but is not limited to, an antenna, a frequency modulation (FM) transceiver, a radio frequency (RF) transceiver, one or more amplifiers, a tuner, one or more oscillators, a digital signal processor, a coder-decoder (CODEC) chipset, a subscriber identity module (SIM) card, and/or a local buffer. The transceiver 214 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as Long Term Evolution (LTE), Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.120 g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The imager 216 may comprise suitable circuitry and/or interfaces that may be configured to transform images (such as a plurality of image frames in the sequence of image frames 110) from analog light signals into a series of digital pixels without any distortion. Examples of implementation of the imager 216 may include, but are not limited to, Charge-Coupled Device (CCD) imagers and Complementary Metal-Oxide-Semiconductor (CMOS) imagers.

The imager controller 218 may comprise suitable logic, circuitry, and/or interfaces that may be configured to control orientation or direction of the imager 216, based on the instructions received from the image processor 202. The imager controller 218 may be implemented by use of several technologies that are well known to those skilled in the art.

The plurality of lenses 220 may correspond to an optical lens or assembly of lenses used in conjunction with a camera body and mechanism to capture images (such as the sequence of image frames 110) of objects (such as the object 112). The images may be captured either on photographic film or on other media, capable to store an image chemically or electronically.

The lens controller 222 may comprise suitable logic, circuitry, and/or interfaces that may be configured to control various characteristics, such as zoom, focus, or iris 220A or aperture, of the plurality of lenses 220. The lens controller 222 may internally be a part of an imaging unit of the image-processing apparatus 102 or may be a stand-alone unit, in conjunction with the image processor 202. The lens controller 222 may be implemented by use of several technologies that are well known to those skilled in the art.

The lens driver 224 may comprise suitable logic, circuitry, and/or interfaces that may be configured to perform zoom and focus control and iris control, based on instructions received from the lens controller 222. The lens driver 224 may be implemented by use of several technologies that are well known to those skilled in the art.

In operation, an exemplary apparatus, such as the image-processing apparatus 102, may capture the sequence of image frames 110 through the plurality of lenses 220. The plurality of lenses 220 may be controlled by the lens controller 222 and the lens driver 224, in conjunction with the image processor 202. The plurality of lenses 220 may be controlled based on an input signal received from a user. The input signal may be provided by the user, via a selection of a graphical button rendered on the display 212A, gesture, and/or a button-press event of a hardware button available at the image-processing apparatus 102. Alternatively, the image-processing apparatus 102 may retrieve another sequence of image frames pre-stored in the memory 204. The sequence of image frames 110 may correspond to a video, such as a video clip, and may include at least the current image frame and the previous image frame.

The background extractor 210 may be configured to compute the plurality of first motion vector values for the plurality of pixels in the current image frame using the optical flow map generated by the optical flow generator 206. The optical flow map may be generated based on a difference of pixel values of the plurality of pixels in the current image frame and the previous image frame. The plurality of first motion vector values may correspond to a relative movement of each of the plurality of pixels from the previous image frame to the current image frame. Such computation of the relative movement of each of the plurality of pixels from the previous image frame to the current image frame may be determined based on various mathematical functions, known in the art. Examples of such mathematical functions may include, but are not limited to, a sum of absolute difference (SAD) function, a sum of squared difference (SSD) function, a weighted sum of absolute difference (WSAD) function, and/or a weighted sum of squared difference (WSSD) function. Notwithstanding, other mathematical functions known in the art may also be implemented for computation of the relative movement of each of the plurality of pixels, without deviation from the scope of the disclosure. Such computed relative movement of each of the plurality of pixels may be represented by the following mathematical expression (1):

$${movement}_{image} [ pixel ] = \vec{{v}_{image}} \qquad ( 1 )$$

In accordance with an embodiment, the background extractor 210 may determine a confidence score for the computed plurality of first motion vector values based on a set of defined parameters. For example, the set of defined parameters may include, but is not limited to, an area covered by one or more foreground objects with respect to a total area of an image frame and/or a contrast level of foreground and background area in the image frame. The determined confidence score of each of the plurality of first motion vector values may indicate an accuracy parameter of the corresponding first motion vector value. For example, a higher confidence score related to a first motion vector value of a pixel may indicate higher accuracy in comparison to a lower confidence score related to a first motion vector value of another pixel. For example, the first motion vector values computed for a first set of pixels that has low contrast ratio in an image frame further exhibits lower confidence score in comparison to first motion vector values computed for a second set of pixels that has higher contrast ratio in the image frame.

The background extractor 210 may be configured to compute the plurality of second motion vector values for the plurality of pixels in the current image frame. The background extractor 210 may compute the plurality of second motion vector values based on the input (such the angular velocity information) provided by the motion sensor 208. The computation of plurality of second motion vector values may be further based on one or more device parameters of the exemplary apparatus, such as the image-processing apparatus 102. Examples of the one or more device parameters may include, but are not limited to, an effective focal length of the plurality of lenses 220, a number of horizontal pixels, and a width of the imager 216. The computed plurality of second motion vector values may be represented as \vec{V_{gyro}_{_}_{based}}. The plurality of second motion vector values may indicate a movement of the plurality of pixels in the current image frame with respect to the previous image frame based on the motion sensor 208. Such movement of the plurality of pixels may be represented by, for example, the following mathematical expression (2):

$${movement}_{gyro} [ pixel ] = \frac{{movement}_{gyro} [ m ]}{Imager size per pixel [ m ]} \qquad ( 2 )$$

where,

$${movement}_{gyro} [ m ] = f tan ( θ \frac{π}{180} ) = f tan ( \vec{ω} Δ t \frac{π}{180} )$$

where,

θ represents a moving angle, computed based on the angular velocity information,

\vec{ω} [deg/sec], received from the motion sensor 208, during time Δt [sec]; and

f [mm] represents focal length of a lens in the plurality of lenses 220. Imager size per pixel [m]=X/H*10⁻³

where,

X represents a width of the imager 216; and

H represents a count of horizontal pixels of the imager 216.

In accordance with an embodiment, the background extractor 210 may be configured to compare the computed plurality of first motion vector values with the plurality of second motion vector values of the plurality of pixels. The background extractor 210 may further determine the similarity parameter for each of the plurality of pixels in the current image frame based on the comparison between the plurality of second motion vector values and the plurality of first motion vector values. Alternatively stated, the determined similarity parameter related to a pixel may indicate a degree of similarity between the corresponding first motion vector value and the corresponding second motion vector value. The background extractor 210 may be further configured to compare the similarity parameter for each of the plurality of pixels in the current image frame with a specified threshold value. The threshold value may be pre-specified by the user 108. The one or more background regions may be extracted from the current image frame based on the comparison between the similarity parameter for each of the plurality of pixels in the current image frame and the specified threshold value. For example, one or more pixels for which the similarity parameter exceeds the specified threshold value may be considered to constitute one or more background regions and hence extracted by the background extractor 210.

In accordance with an embodiment, the background extractor 210 may be further configured to generate a confidence map based on the determined confidence score and the determined similarity parameter for each of the plurality of pixels. The confidence map may graphically represent the extracted one or more background regions in accordance with the confidence scores. Alternatively stated, the generated confidence map may indicate the confidence level with which the background extractor 210 has detected and extracted each of the one or more background regions. A background region associated with a higher confidence level in the confidence map may indicate that the likelihood of the extracted region to represent an actual background region in the current image frame is higher in comparison to another background region associated with a lower confidence level in the confidence map. A pixel associated with a lower confidence score is further associated with a lower confidence level and another pixel associated with a higher confidence score is further associated with a higher confidence level in the generated confidence map. Thus, a background region including pixels that have lower confidence score may be associated with a lower confidence level in the confidence map.

In accordance with an embodiment, the background extractor 210 may be further configured to provide the extracted one or more background regions and the generated confidence map to the image processor 202. The image processor 202 may be configured to detect an object-of-interest (such as the object 112) in the current image frame based on the extracted one or more background regions and the generated confidence map. The image processor 202 may further perform one or more image processing operations on the object-of-interest. The one or more image processing operations may include, but are not limited to, autofocusing on the object-of-interest, enhancing visual parameters (such as color, hue, saturation, contrast, and/or brightness) of the object-of-interest. An example of the extraction of the one or more background regions is depicted in FIG. 3.

FIG. 3 illustrates an exemplary scenario for optical flow and sensor based background subtraction in video content, in accordance with an embodiment of the disclosure. FIG. 3 is explained in conjunction with elements from FIGS. 1 and 2. With reference to FIG. 3, there is shown an exemplary scenario 300 that includes a previous image frame 302 and a current image frame 304 which correspond to a scene of a live soccer match. The scene includes four soccer players, spectators, and the soccer field. The imaging device, such as the image-processing apparatus 102, is set at maximum zoom. Thus, the soccer players in the scene appears to nearer to the image-processing apparatus 102 in comparison to the spectators and the soccer field, and occupies the majority portion of the previous image frame 302 and the current image frame 304. The captured scene may correspond to video content. The spectators and the soccer field may correspond to one or more background regions and the four soccer players may correspond to the objects-of-interest (i.e., the one or more foreground regions). The exemplary scenario 300 further includes an optical flow map 306, a sensor input 308, and different output (such as an output 312) of background subtraction generated by the background extractor 210. There is further shown the optical flow generator 206, the motion sensor 208, and the background extractor 210 (FIG. 2).

For the sake of brevity, a plurality of regions in the optical flow map 306 is shown with different patterns. However, those skilled in the art will understand that scope of the disclosure is not limited to the exemplary representation of the optical flow map 306 so as to resemble a real optical flow map. For example, the plurality of regions in a real optical flow is usually represented by different colors shades or intensity variation of same color.

With reference to the exemplary scenario 300, the previous image frame 302 and the current image frame 304 may correspond to the sequence of image frames 110. The previous image frame 302 may be captured at a time instant, t-1, and the current image frame 304 may be captured at a next time instant, t. The optical flow generator 206 may generate the optical flow map 306, based on one or more techniques, known in the art. The optical flow map 306 may comprise a plurality of regions 306a, . . . , 306j. The regions 306a, 306b, and 306g in the plurality of regions 306a, . . . , 306j correspond to the four soccer players in the scene. The regions 306h and 306j corresponds to the spectators in the scene. Further, the regions 306c, 306d, 306e, and 306i correspond to the soccer field in the scene.

The optical flow generator 206 may provide the generated optical flow map 306 to the background extractor 210. The background extractor 210 may compute the plurality of first motion vector values for the plurality of pixels in the current image frame 304 based on the optical flow map 306 by using the mathematical expression (1), as described in FIG. 2. The background extractor 210 may further receive the sensor input 308 (such as the angular velocity information) from the motion sensor 208. The background extractor 210 may then compute the plurality of second motion vector values for the plurality of pixels in the current image frame 304 based on the sensor input 308. The background extractor 210 may further utilize the one or more device parameters (such as the focal length of the plurality of lenses 220, the number of horizontal pixels, and the width of the imager 216) of the image-processing apparatus 102 for the computation of the plurality of second motion vector values The background extractor 210 may compute the plurality of second motion vector values based on the mathematical expression (2), as described in FIG. 2, applied on the sensor input 308 corresponding to the previous image frame 302 and the current image frame 304.

The background extractor 210 may extract the one or more background regions from the current image frame 304 based on the plurality of first motion vector values. The background extractor 210 may extract the one or more background regions 314B, . . . , 314I from the current image frame 304 based on the plurality of first motion vector values and the plurality of second motion vector values, as shown in the output 312 of the background extractor 210. The extracted one or more background regions 314B, . . . , 314I included in the output 312 may accurately represent the actual one or more background regions of the current image frame 304. The background extractor 210 may further compare the computed plurality of first motion vector values with the plurality of second motion vector values of the plurality of pixels to determine the similarity parameter for each of the plurality of pixels in the current image frame 304. The background extractor 210 may then compare the similarity parameter of each of the plurality of pixels with a specified threshold value to extract the one or more background regions 314B, . . . , 314I in the current image frame 304.

In accordance with an embodiment, the background extractor 210 may determine a confidence score for the computed plurality of first motion vector values based on a set of defined parameters. The set of defined parameters may include, but is not limited to, an area covered by a foreground object(s) in an image frame with respect to total area of the image frame and/or a contrast level of the image frame.

In accordance with an embodiment, the background extractor 210 may generate a confidence map based on the determined confidence score and the determined similarity parameter for each of the plurality of pixels in the current image frame 304. The confidence map may represent one or more background regions (the extracted one or more background regions 314B) in accordance with the confidence score. For example, the background regions 314C and 314D have lower confidence level as compared to the background regions 314B and 314D, . . . , 314I in the generated confidence map. Thus, the likelihood of the background regions 314C and 314D to represent the actual (or true) background regions of the current image frame 304 is lesser in comparison to the likelihood of the background regions 314B and 314D, . . . , 314I to represent the actual (or true) background regions of the current image frame 304.

In accordance with an embodiment, the image processor 202 may detect the one or more foreground regions of the current image frame 304 based on the output 312 and the generated confidence map. The image processor 202 may detect any region apart from the extracted one or more background regions 314B, . . . , 314I as the one or more foreground regions of the current image frame 304. In accordance with an embodiment, the image processor 202 may include the background regions 314C and 314D in the detected one or more foreground regions due the lesser confidence level in the generated confidence map as compared to the background regions 314B and 314D, . . . , 314I. The image processor 202 may then perform one or more image processing operations on the one or more foreground regions.

In accordance with an embodiment, the image-processing apparatus 102 may correspond to an imaging device, (for example, a digital camera or a camcorder). The imaging device may use the extracted one or more background regions (such as the one or more background regions 314B, . . . , 314I) to detect one or more objects-of-interest in the current image frame 304. The imaging device may be further used to detect one or more objects in motion in the current image frame 304. The one or more objects in motion may correspond to the one or more objects-of-interest. Further, the imaging device may be used to autofocus on the detected one or more objects-of-interest. One or more visual parameters (for example, brightness, contrast, hue, saturation, or color) of one or more objects-of-interest may be modified by the imaging device based on the extraction of the one or more background regions. The image-processing apparatus 102 may be used for example, as a video surveillance device.

The extraction of the one or more background regions (such as the one or more background regions 314B, . . . , 314I) from an image frame (such as the current image frame 304) based on the plurality of first motion vector values and the plurality of second motion vector values may provide an ability to apparatus, such as the image-processing apparatus 102, to accurately segregate the one or more foreground regions from the one or more background regions. Further, the image-processing apparatus 102 extracts the one or more background regions (such as the one or more background regions 314B, . . . , 314I) with better accuracy in comparison to the conventional image-processing apparatuses, in a scenario where the area covered by the one or more foreground regions in an image frame is relatively larger than the area covered by the one or more background regions in the image frame. Alternatively stated, the disclosed apparatus and method extracts the one or more background regions from an image frame accurately in a scenario when the area covered by the one or more background regions is relatively smaller than the area covered by the one or more foreground regions in the image frame.

FIGS. 4A and 4B, collectively, depict a flowchart that illustrates exemplary operations for optical flow and sensor based background subtraction in video content, in accordance with an embodiment of the disclosure. With reference to FIGS. 4A and 4B, there is shown a flowchart 400. The flowchart 400 is described in conjunction with FIGS. 1, 2, and 3. The operations, implemented at the image-processing apparatus 102 for optical flow and sensor based background subtraction in video content, begin at 402 and proceed to 404.

At 404, video content that includes a sequence of image frames may be captured. The image processor 202 in the image-processing apparatus 102 may instruct the lens controller 222 and the imager controller 218 to control the plurality of lens 220 and the imager 216 to capture the sequence of image frames of the video content. In accordance with an embodiment, the image-processing apparatus 102 may retrieve the sequence of image frames of the video content from the memory 204 and/or the server 104. The sequence of image frames may include at least a current image frame and a previous image frame. An example is shown and described in FIG. 3, where the image-processing apparatus 102 captures the sequence of image frames 110 that includes the previous image frame 302 and the current image frame 304.

At 406, an optical flow map of the current image frame of the video content may be generated. The optical flow generator 206 may be configured to generate the optical flow map based on the current image frame and previous image frame. An example is shown and described in FIG. 3, where the optical flow generator 206 generates the optical flow map 306 based on the current image frame 304 and previous image frame 302.

At 408, a plurality of first motion vector values for a plurality of pixels in the current image frame with respect to the previous image frame may be computed. The background extractor 210 may be configured to compute the plurality of first motion vector values for the plurality of pixels in the current image frame by using the optical flow map. An example is shown and described in FIGS. 2 and 3, where the background extractor 210 computes the plurality of first motion vector values for the plurality of pixels in the current image frame 304 by using the optical flow map 306. The background extractor 210 may implement various algorithms and mathematical functions (for example mathematical expression (1), as described in FIG. 2) for the computation of the plurality of first motion vector values.

At 410, a sensor input from a motion sensor may be received. The background extractor 210 may be configured to receive the sensor input from the motion sensor 208. An example is shown and described in FIGS. 2 and 3, where the background extractor 210 receives the sensor input 308 (such as the angular velocity information) from the motion sensor 208.

At 412, a plurality of second motion vector values may be computed for the plurality of pixels in the current image frame. The background extractor 210 may be configured to compute the plurality of second motion vector values for the plurality of pixels in the current image frame based on the received sensor input. An example is shown and described in FIGS. 2 and 3, where the background extractor 210 computes the plurality of second motion vector values for the plurality of pixels in the current image frame 304 based on the received sensor input 308. The background extractor 210 may implement various algorithms and mathematical functions (for example mathematical expression (2), as described in FIG. 2) for the computation of the plurality of second motion vector values.

At 414, a confidence score may be determined for the plurality of first motion vector values. The background extractor 210 may be configured to determine the confidence score for the plurality of first motion vector values based on the set of defined parameters. An example is shown and described in FIGS. 2 and 3, where the background extractor 210 determines the confidence score for the plurality of first motion vector values based on the set of defined parameters.

At 416, the plurality of second motion vector values may be compared with the plurality of first motion vector values. The background extractor 210 may be configured to compare the plurality of second motion vector values with the plurality of first motion vector values. An example is shown and described in FIGS. 2 and 3, where the background extractor 210 compares the plurality of second motion vector values with the plurality of first motion vector values.

At 418, a similarity parameter may be determined for each of the plurality of pixels in the current image frame. The background extractor 210 may be configured to similarity parameter determine for each of the plurality of pixels in the current image frame based on the comparison of the plurality of second motion vector values with the plurality of first motion vector values. An example is shown and described in FIGS. 2 and 3, where the background extractor 210 determines the similarity parameter for each of the plurality of pixels in the current image frame 304.

At 420, the similarity parameter related to a pixel in the plurality of pixels may be compared with a specified threshold value. The background extractor 210 may be configured to compare the similarity parameter related to a pixel in the plurality of pixels with the specified threshold value. The threshold value may be pre-specified by the user 108 associated with the image-processing apparatus 102. An example is shown and described in FIGS. 2 and 3, where the background extractor 210 compares the similarity parameter related to each of the plurality of pixels in the current image frame 304 with a specified threshold value.

At 422, the pixels for which the similarity parameter exceeds the specified threshold value may be included in one or more background regions. The background extractor 210 may be configured to include the pixels for which the similarity parameter exceeds the specified threshold value in the one or more background regions that are to be extracted. The background extractor 210 may include all the pixels in the one or more background regions for which the corresponding similarity parameter exceeds the specified threshold value.

At 424, the one or more background regions may be extracted from the current image frame. The background extractor 210 may be configured to extract the one or more background regions that include all the pixels for which the corresponding similarity parameter exceeds the specified threshold value from the current image frame. The background extractor 210 may further generate a confidence map indicating a confidence level with which a pixel in the plurality of pixels is extracted to be included in the one or more background regions. The confidence map may be generated based on the similarity parameter and the confidence score related to the plurality of first motion vector values of the plurality of pixels in the current image frame. The background extractor 210 may provide the extracted one or more background regions to the image processor 202 for further processing (for example, detecting the one or more foreground regions or to auto-focus on the objects-of-interests) of the current image frame 304. An example is shown and described in FIGS. 2 and 3, where the background extractor 210 extracts the one or more background regions 314B, . . . , 314I from the current image frame 304. The control may pass to the end 426.

In accordance with an embodiment of the disclosure, an apparatus for image processing is disclosed. The apparatus, such as the image-processing apparatus 102 (FIG. 1), may comprise one or more processors (such as the image processor 202, the optical flow generator 206, the background extractor 210 (FIG. 2)). The background extractor 210 may be configured to compute a plurality of first motion vector values for a plurality of pixels in a current image frame (such as the current image frame 304 (FIG. 3)) with respect to a previous image frame (such as the previous image frame 302 (FIG. 3)) using an optical flow map (such as the optical flow map 306 (FIG. 3)). The background extractor 210 may be configured to compute a plurality of second motion vector values for the plurality of pixels in the current image frame 304 based on an input (such as the sensor input 308 (FIG. 3)) received from a sensor (such as the motion sensor 208 (FIG. 2)) provided in the image-processing apparatus 102. The background extractor 210 may be further configured to determine a confidence score for the plurality of first motion vector values based on a set of defined parameters. The background extractor 210 may be further configured to extract one or more background regions (such as the one or more background regions 314B, . . . , 314I (FIG. 3)) from the current image frame 304 based on the determined confidence score and a similarity parameter between the plurality of first motion vector values and the plurality of second motion vector values.

Various embodiments of the disclosure encompass numerous advantages that include an apparatus and method for optical flow and sensor input based background subtraction in video content. The optical flow and sensor input based background subtraction overcomes the faulty background extraction in case the objects-of-interests are near to the image-capture device. For example, in case of capturing an image frame of a scene with maximum zoom, the objects-of-interests appear to be very close to the image capturing device and occupy a majority portion of the captured image frame. For example, as illustrated in FIG. 3, the image-processing apparatus may be operated at a maximum zoom, thus the four soccer players occupy the majority portion of the current image frame 304 and the previous image frame 302. In this scenario, the background region occupies lesser portion compared to the objects-of-interests. Usually, the background extraction in such a scenario by conventional apparatuses and methods may be inaccurate as the conventional apparatuses extract the largest portion in an image frame as the background region. The background extractor 210 enables the image-processing apparatus 102 to extract the one or more background regions accurately irrespective of background area coverage in an image.

The background extractor 210 further generates a confidence map indicating a likelihood of an extracted background region to represent an actual background region of the image frame. Thus, the image processor 202 may utilize the confidence map and the extracted one or more background regions to identify the high confidence background regions, which may be utilized to further process the image frame.

Various embodiments of the disclosure may provide a non-transitory, computer readable medium and/or storage medium, and/or a non-transitory machine readable medium and/or storage medium having stored thereon, a machine code and/or a computer program with at least one code section executable by a machine and/or a computer for image processing. The at least one code section may cause the machine and/or computer to perform the operations that comprise computation of a plurality of first motion vector values for a plurality of pixels in a current image frame with respect to a previous image frame using an optical flow map. A plurality of second motion vector values may be computed for the plurality of pixels in the current image frame based on an input received from a sensor provided in an apparatus. A confidence score for the plurality of first motion vector values may be determined based on a set of defined parameters. One or more background regions may be extracted from the current image frame based on the determined confidence score and a similarity parameter between the plurality of first motion vector values and the plurality of second motion vector values.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features that enable the implementation of the methods described herein, and which when loaded in a computer system is able to carry out these methods. While the present disclosure has been described with reference to certain embodiments, it will be understood by those skilled in the art that various changes may be made and equivalents may be substituted without departure from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments that fall within the scope of the appended claims.

What is claimed is:

1. An apparatus for image processing, comprising:
one or more processors configured to:
compute a plurality of first motion vector values for a plurality of pixels in a current image frame with respect to a previous image frame using an optical flow map;
compute a plurality of second motion vector values for said plurality of pixels in said current image frame based on an input received from a sensor provided in said apparatus;
determine a confidence score for said plurality of first motion vector values based on a set of defined parameters; and
extract one or more background regions from said current image frame based on said determined confidence score and a similarity parameter between said plurality of first motion vector values and said plurality of second motion vector values.

2. The apparatus according to claim 1, wherein said one or more processors are further configured to capture a sequence of image frames, wherein said sequence of image frames includes at least said current image frame and said previous image frame.

3. The apparatus according to claim 1, wherein said one or more processors are further configured to generate said optical flow map based on a difference of pixel values of said plurality of pixels in said current image frame and said previous image frame.

4. The apparatus according to claim 1, wherein said received input corresponds to angular velocity information of each of said plurality of pixels in said current image frame.

5. The apparatus according to claim 1, wherein each of said plurality of first motion vector values corresponds to a relative movement of each of said plurality of pixels from said previous image frame to said current image frame.

6. The apparatus according to claim 1, wherein said plurality of second motion vector values corresponds to a plurality of motion vector values computed for a gyro sensor provided in said apparatus.

7. The apparatus according to claim 1, wherein said computation of said plurality of second motion vector values is further based on one or more device parameters of said apparatus, wherein said one or more device parameters comprise a focal length of a lens of said apparatus, a number of horizontal pixels, and a width of an imager component provided in said apparatus.

8. The apparatus according to claim 1, wherein said one or more processors are further configured to compare said plurality of second motion vector values with said plurality of first motion vector values of said plurality of pixels for extraction of said one or more background regions.

9. The apparatus according to claim 8, wherein said one or more processors are further configured to determine said similarity parameter for each of said plurality of pixels in said current image frame based on said comparison between said plurality of second motion vector values and said plurality of first motion vector values.

10. The apparatus according to claim 9, wherein said one or more processors are further configured to generate a confidence map based on said confidence score and said similarity parameter related to each of said plurality of pixels.

11. The apparatus according to claim 10, wherein said one or more background regions are extracted based on a comparison of said determined similarity parameter related to each of said plurality of pixels with a specified threshold value.

12. The apparatus according to claim 1, wherein said current image frame comprises one or more foreground regions and said one or more background regions.

13. An image-processing system, comprising:
one or more processors in an imaging device configured to:
compute a plurality of first motion vector values for a plurality of pixels in a current image frame with respect to a previous image frame using an optical flow map;
compute a plurality of second motion vector values for said plurality of pixels in said current image frame based on an input received from a sensor provided in said imaging device;
determine a confidence score for said plurality of first motion vector values based on a set of defined parameters;
extract one or more background regions from said current image frame based on said determined confidence score and a similarity parameter between said plurality of first motion vector values and said plurality of second motion vector values; and
detect one or more objects-of-interest in said current image frame based on said extracted one or more background regions.

14. The image-processing system according to claim 13, wherein said detected one or more objects-of-interest corresponds to one or more objects in motion in said current image frame.

15. The image-processing system according to claim 13, wherein said one or more processors in said imaging device are further configured to autofocus on said detected one or more objects-of-interest.

16. The image-processing system according to claim 13, wherein said one or more processors in said imaging device are further configured to modify one or more visual parameters of said detected one or more objects-of-interest.

17. A method for image processing, said method comprising:
in an apparatus that is configured to handle a sequence of image frames:
computing a plurality of first motion vector values for a plurality of pixels in a current image frame with respect to a previous image frame using an optical flow map;
computing a plurality of second motion vector values for said plurality of pixels in said current image frame based on an input received from a sensor;
determining a confidence score for said plurality of first motion vector values based on a set of defined parameters; and
extracting one or more background regions in said current image frame based on said determined confidence score and a similarity parameter between said plurality of first motion vector values and said plurality of second motion vector values.

18. The method according to claim 17, further comprising generating said optical flow map based on a difference of pixel values of said plurality of pixels in said current image frame and said previous image frame.

19. The method according to claim 17, further comprising comparing said plurality of second motion vector values with said plurality of first motion vector values of said plurality of pixels for extraction of said one or more background regions.

20. The method according to claim 19, further comprising determining said similarity parameter for each of said plurality of pixels in said current image frame based on said comparison between said plurality of second motion vector values and said plurality of first motion vector values.
